(19) United States
(12) Patent Application Publication
(10) Pub. No.: US 2003/0233577 A1
(43) Pub. Date: Dec. 18, 2003

(54) Electronic mail system, method and apparatus

(76) Inventor: Frank Bellino, Staten Island, NY (US)

Correspondence Address: Brull Piccionelli Sarno Braun & Vradenburgh, Suite 2350, 1925 Century Park East, Los Angeles, CA, 90067, US

(21) Appl. No.: 10/175,971

(22) Filed: Jun. 18, 2002

(51) Int. Cl. G06F 11/30

(52) U.S. Cl. 713/201

(57) ABSTRACT

Embodiments of the present invention are directed to an electronic mail system that is configured to filter transmissions such that the subscriber of the electronic mail account does not receive unsolicited, or undesired transmissions. Embodiments of the electronic mail system allow for the authentication of transmission via comparison of the sender's identification to a listing of authorized identifications in an authentication database or via a subscriber defined authorization code. If the sender's identification is not found within the authentication database, the system reviews the transmission for the presence of the authorization code. If the code is not present the transmission is blocked. If the sender's identification is found in the authentication database or the code is present in the transmission, the transmission is received by the system

### FIELD OF THE INVENTION

The present invention is directed to a system, method and apparatus for filtering unauthorized data and transmissions. More specifically, an electronic mail system that filters communications and data from third parties, and prevents the transmission of unauthorized communications and data to subscribers of the electronic mail system.

### BACKGROUND OF THE INVENTION

Wide area networks, such as the Internet, or World Wide Web (“WWW”) provide access to users for nearly any type of information. Further, wide area networks allow for virtually instantaneous transmission and receipt of information. In this regard, individual users can directly communicate with each other via the wide area network utilizing preestablished communication means, such as, e-mail or instant messaging systems. The ability to directly communicate with family and friends has provided a great benefit to users, and thus, most users have established an electronic mail (“e-mail”) address, that is, an on-line location for other users to forward information.

The use of e-mail has become a widely practiced manner of communicating with others Indeed, the use of e-mail has allowed families and friends to stay in contact more easily, with more frequency, and without much effort. Unfortunately, the benefits of e-mail has also become apparent to merchants and vendors of a wide variety of goods and services. Thus, e-mail lists, akin to mailing lists, are now a valuable marketing tool as they provide direct access to users for purposes of solicitation.

In light of the value of e-mail lists, e-mail lists are sold for the purpose of forwarding solicitations and advertisements. Indeed, bulk e-mail, coined spam, is a common method of distributing advertisements. Due to the effortless manner in which the advertisements can be distributed, bulk e-mail has become problematic. Indeed, the problem is so extensive that laws have been passed prohibiting ‘spamming’.

Currently, programs have been developed that attempt to filter unauthorized e-mail. In one instance, e-mail is sorted by reviewing the subject or ‘re’ line. If the subject line contains key words, the e-mail is blocked or placed into a bulk folder, wherein the user can determine whether to review the e-mail. Although this method of filtering e-mails is somewhat useful, it is not completely effective. Indeed, many e-mails with clearly identifiable marketing terms in the subject line are not removed to the bulk folder. Further still, to avoid this filter advertisers merely change the subject line to terms that appear to be personal, such as, ‘hello’, or ‘in response to your inquiry’ and the like. Thus, many unauthorized and unwanted e-mails must still be reviewed, or minimally, sorted, by the user. In other instances, the programs review the ‘bcc’ or ‘cc’ list. In this manner, if an extremely high number of users are listed in the ‘bcc’ or ‘cc’ list, the program assumes that the current transmission is unsolicited mail or spam.

Despite the laws, and the current attempts to minimize spam, many users of e-mail receive, on almost a daily basis, numerous unwanted e-mail. The volume of unwanted e-mail causes a plurality of problems, including, the absorption of valuable computer space and the wasting of user time in sorting the unwanted e-mail from the desired e-mail. A need in the industry exists for a filtering system that more effectively filters and prevents the receipt of unauthorized and unwanted e-mail. A further need exists for a system that does not allow the sender of the e-mail the ability to mask the e-mail and bypass the filtering mechanism

### BRIEF DESCRIPTION OF THE DRAWINGS

The detailed description of embodiments of the invention will be made with reference to the accompanying drawings, wherein like numerals designate corresponding parts in the figures

FIG. 1 is a data filtering system in accordance with preferred embodiments of the invention as integrated into a network system.

FIG. 2 is a schematic of the operation of the data filtering system in accordance with the preferred embodiment of FIG. 1.

### SUMMARY OF THE DISCLOSURE

Embodiments of the present invention are directed to an electronic mail system that is configured to filter transmissions such that the subscriber of the electronic mail account does not receive unsolicited, or undesired transmissions. Embodiments of the electronic mail system operate on a network having a provider computer, a subscriber computer, and a transmitting computer, capable of communication with each other via the network.

The electronic mail system comprises distribution members, storage members and a filtering engine. The distribution members comprise a receiving member and a retrieval member, wherein the receiving member is configured to receive transmissions from transmitting computers. The receiving members verify authentication of the transmission prior to storing the transmission in a storage location. The retrieval member retrieves the stored transmissions for the subscriber's review.

The storage members are databases and comprise an authentication database and a storage database. The authentication database stores listings of sender identification, wherein only transmissions from senders listed in the authentication database are authorized and will be received by the receiving member. The storage database stores the transmissions and other relevant information regarding the subscriber's account, including, the location of the account.

To authenticate a transmission, a request for authentication is transmitted by the receiving member to the filtering engine. Upon receipt of the request for authentication, the filtering engine compares the sender's identification in the transmission with the authentication database If the sender's identification is contained in the listing, the transmission is authorized.

In addition to the authentication database, the electronic mail system can authenticate the transmission utilizing an authorization code, or ‘secret’ which is chosen by the subscriber. The secret is initially chosen when the account is established, however, the secret can be changed at any time. If the subscriber desires to receive transmissions from a third party not listed in the authentication database, the subscriber need only give the authorization code to the third party The third party must include the secret within the transmission. Upon the detection of the secret within the transmission, the filtering engine will authorize the transmission and, optionally, can add the third party identification to the subscriber's authorization database.

A feature of preferred embodiments is that members of the transmission filtering system can designate parties from whom they will receive information. An advantage to this feature is that the member will only receive information from designated parties.

A further feature of preferred embodiments is that temporary e-mail addresses can be established for a predefined amount of time. An advantage to this feature is that members can purchase goods and services on-line and receive a confirmation of the order, and prevent the receipt of additional unwanted e-mail from the vendor of the product or service.

A still further feature of preferred embodiments is that members can change their authorization list at any time. An advantage to this feature is that the members can reestablish their approved receipt list.

Another feature of preferred embodiments is that the sender of a message containing the member's secret in the subject line can, optionally, be automatically incorporated into the approved list. An advantage to this feature is that members are not required to constantly update their approved receipt list in conjunction with distributing their e-mail address to a new person.

Another feature of preferred embodiments is that members can change their filtering mechanism, that is, their ‘secret’, at any time. An advantage to this feature is that the members can automatically block all users utilizing the secret that have not automatically been incorporated into the approved list.

A further feature of preferred embodiments is that a member can automatically add an e-mail address to the approved list by transmitting a message to the e-mail address. An advantage to this feature is that the member is not required to separately update the approved list

A still further feature of preferred embodiments is that e-mail messages not containing the secret in the subject line or from a sender not on the approved list will be blocked by the filtering system. An advantage to this feature is that the member of the filtering system will not receive e-mail messages from non-authorized senders and thereby reduce, or even eliminate, the amount of undesired e-mail.

Another feature of preferred embodiments is that an e-mail address on the approved list can be suspended, or blocked, without removing the e-mail address from the approved list. An advantage to this feature is that the member can activate and de-activate e-mail addresses at will without the requirement of changing the secret or sending an e-mail to the address to reactivate the address.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### DETAILED DESCRIPTION OF PREFERRED EMBODIMENTS

Preferred embodiments of the instant invention operate on a network, such as, for example, the Internet or World Wide Web (“WWW”), or any other type of network system, including, an internet or an intranet.

Hardware Environment:

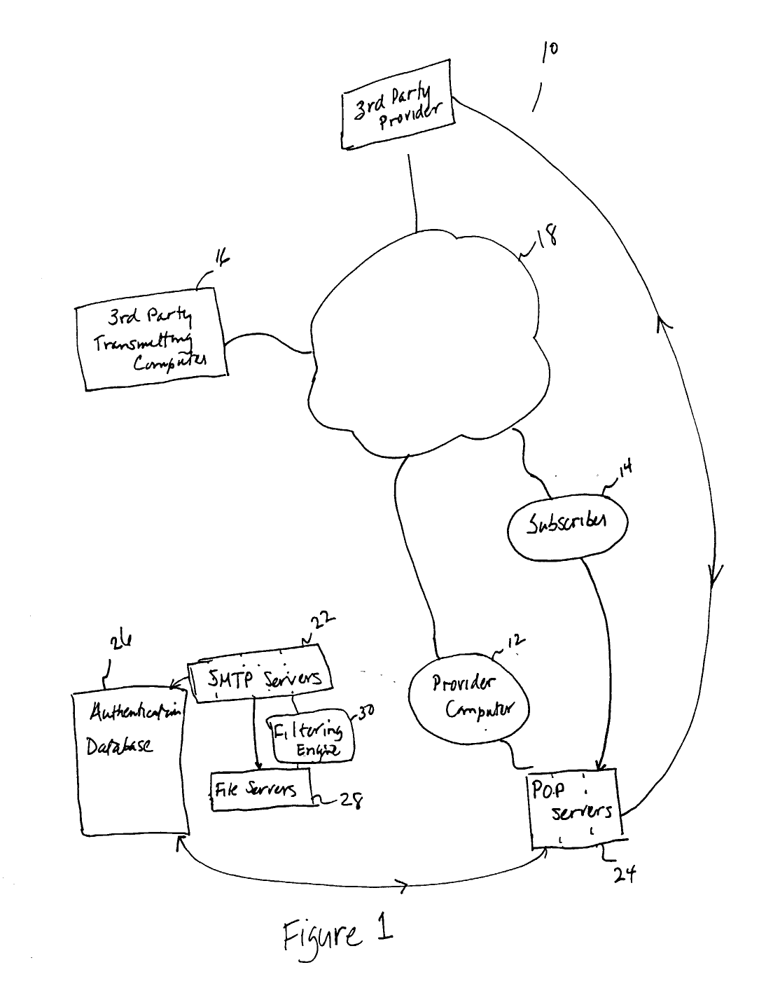

Preferred embodiments of the instant invention operate in accordance with a plurality of networked computers, such as, for example, a user or subscriber computer and a provider computer which are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, a subscriber computer 14, a third party or transmitting computer 16, wherein the provider computer 12, the subscriber computer 14 and the transmitting computer 16 are in electronic communication with each other via a communication link 18. In preferred embodiments, a third party provider computer 15 is also in electronic communication with the network system 10.

In some preferred embodiments, the network system 10 includes a plurality of either the provider computer 12, the subscriber computer 14 or any combination thereof. The provider computer 12, or server, may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media (for example, but not limited to, floppy disks, hard disks, random access memory RAM, CD-ROM), to provide content for communication to a subscriber computer 14. The provider computer 12 may comprise, for example, but not limited to, a personal computer, a mainframe computer, network computer, portable computer, personal digital assistant (such as, a 3Com Palm Pilot), or the like. The provider computer 12 may include one or more internal data storage devices (not shown) for storing content for communication to a user computer 14. Alternatively, or in addition, the provider computer 12 may be coupled to an external data storage device, computer or other means (not shown) from which the provider computer 12 may obtain content for communication to the subscriber computer 14. In one embodiment, the external device may comprise a further network device coupled in the network 18. The provider computer 12 is controlled by suitable software to provide the requested content to the requesting subscriber computer 14, provided that various criteria are met.

In a preferred wide area network environment, such as the Internet environment, the provider computer 12 is controlled by suitable software to respond to a valid request for content by providing (or downloading) data to the subscriber computer 14 from which the request was made. It will be understood by those skilled in the art that this process involves communications through suitable servers, routers and other components, as is dictated by the particular network environment.

The provider computer 12 operates with a persistent storage means (not shown), for example, one or more of the fixed and/or removable data storage devices and/or data communications devices connected to the computer. The communication link 18 may include a public network, such as the Internet, a local area network, or any other suitable communications connection, hardwired, wireless, or a hybrid thereof

The subscriber computer 14 may comprise any suitable network device capable of communicating with other network devices in the network system. In preferred embodiments, each subscriber computer comprises a programmable processor capable of operating in accordance with programs stored on one or more computer readable media (for example, but not limited to floppy disc, hard disc, computer network, random access memory (RAM), CD Rom, or the like), a display device for providing a user-perceivable display (for example, but not limited to visual displays, such as cathode ray tube CRT displays, light-emitting-diode LED or liquid-crystal-diode LCD displays, plasma displays or the like, audio displays or tactile displays), and a user input device (for example, but not limited to, a keyboard, mouse, microphone, or the like). In one preferred embodiment, at least one subscriber computer comprises a personal computer system having a CRT display, a keyboard and a mouse user-input device.

The subscriber computer 14 is controlled by suitable software, including network communication and browser software to allow a user to request, receive and display information (or content) from or through a provider computer 12 on the network system 10. The subscriber computer 14 operates in accordance with programs stored on a readable medium, including, but not limited to, floppy disks, hard disks, RAM and CD-ROM. The subscriber computer 14 is any means capable of communicating with the provider computer 12, including, but not limited, to personal computers, kiosks and ATM-type machines. The subscriber computer 14 accesses the provider computer 12 via the wide area network or through some other remote access, such as, for example, by telephone, facsimile, personal digital assistant, pulse code system, web TV, or any other device or method that communicates alpha numeric data with a server.

The transmitting computer 16 is similar to the subscriber computer 14, and thus, the description set forth above is applicable to the transmitting computer 16. In preferred embodiments, although the transmitting computer 16 is configured to access the provider computer 12, the transmitting computer 16, generally, simply forwards data transmissions via a third party provider computer 17, wherein the transmission is forward to the provider computer 12 by predefined Internet protocol. It is to be understood that the transmitting computer 16 can access the wide area network via other provider computers, and the configuration of FIG. 1 is intended to be only illustrative.

General Description Of Preferred Embodiments:

Embodiments of the present invention are directed to a method, apparatus and system for filtering unauthorized data. More specifically, embodiments of the present invention are directed to an electronic mail system that filters communications and data from third parties, and prevents the transmission of unauthorized data to subscribers of the electronic mail system

With reference again to FIG. 1, the electronic mail system operates on a network having a provider computer 12, at least one client or subscriber computer 14, and a third party or transmitting computer 16. The electronic mail system comprises distribution members 22, 24 storage databases 26, 28 and a filtering engine 30 coupled together in electronic communication with each other and the provider computer 12.

The distribution members comprise at least one receiving member 22 and at least one retrieval member 24. It is to be understood that in some preferred embodiment the electronic mail system includes a plurality of receiving members or a plurality of retrieval members, or any combination thereof In preferred embodiments, the receiving member 22 is a server, or any other suitable apparatus, including, but not limited to, a personal computer, a mainframe computer, network computer, portable computer, or the like, capable of receiving data transmission from transmitting computers 16. In some preferred embodiments, the receiving members 22 are simple mail transfer protocol (“SMTP”) servers, wherein the SMTP servers are configured in accordance with the SMTP standard known by those reasonably skilled in the art. The SMTP servers are the ‘front end’ apparatuses that accept data transmissions, for example, electronic mail, from third parties and forward the transmissions to appropriate storage locations for later retrieval.

The retrieval members 24 are considered the ‘back end’ of the system and facilitate the retrieval of the mail by the user, or subscriber, that has been stored by the SMTP servers. The retrieval member is a server, or any suitable apparatus, including, but not limited to, a personal computer, a mainframe computer, network computer, portable computer, or the like, capable of retrieving the previously stored transmissions for the subscriber. In one preferred embodiment, the retrieval member is a POP server, wherein the POP server is configured in accordance with the POP standard known by those reasonably skilled in the art. The POP servers also forward electronic mail originating from the subscribers to the wide area network, such as the Internet In addition to retrieving electronic mail stored on the system, the POP servers are configured to retrieved electronic mail from other electronic mail services, such as, Yahoo!, to which the subscriber is a member. In some preferred embodiments, the mail is retrieved in bulk and reviewed for authenticity prior to being stored in the system storage locations.

The storage databases comprise an authentication database 26 and a storage database 28 The authentication database 26 and storage databases 28 are file servers for storing information. The authentication database 26 stores the approved sender's identification, wherein approval indicates that a data transmission will be accepted by the system. As will be discussed below, information contained in the authentication database 24 can be entered manually by the subscriber, or can be automatically updated.

The storage database 28 stores system mailboxes, mail queues, and auxiliary files associated with the electronic mail service. Mail received by the SMTP servers is stored in the storage databases 28, wherein prior to storage of the received mail, the sender of the data transmission is authenticated by the filtering system via the filtering engine 30.

The filtering engine 30 is a software program configured to determine whether a transmission is authorized. Upon receipt of a transmission from the SMTP servers, the filtering engine compares the sender's identification, such as, a user name, associated with the transmission with the list of authorized identifications in the authentication database 26. If the sender's identification is contained in the list, the filtering engine 30 transmits an authorization notification to the SMTP server. Upon receipt of the authorization notification, the SMTP server 22 stores the transmission in the storage database 28 for later retrieval. If the sender's identification is not contained in the list, the filtering engine 30 reviews the transmission for an authorization code (discussed below). If the authorization code is present within the transmission, the filtering engine 30 transmits an authorization notification to the SMTP server 22 so that the transmission can be stored. If the filtering engine 30 does not find the sender's identification in the authentication database, nor the authorization code within the transmission, the filtering engine 30 transmits a non-authorization message to the SMTP server 22. The SMTP server, in turn, blocks the transmission from entering the electronic mail system and transmits a ‘transmission unacceptable’ notice back to the sender.

Prior to the system being utilized by a subscriber, the subscriber must register with the electronic mail system and establish an account. To register with the electronic mail system, the subscriber accesses the mail system via an interface, such as a web page, transmitted to the subscriber by the provider computer 12. The interface includes a ‘sign-Up’ button, or any other interface that may be suitable. Upon depression of the ‘Sign-Up’ button, a sign up page is transmitted to the subscriber, wherein the subscriber inputs identifying information, including, but not limited to, a user name, or other unique identification, and a password. In one preferred embodiment, the information is input via input boxes. Once the subscriber is satisfied that the input information is accurate, the subscriber submits the information to the system via a ‘submit’ button. The submitted information is then transmitted to the storage database 28.

Once the subscriber has established or opened an account, the subscriber inputs a list of authorized sender identifications, such as, a list of authorized user names, wherein each sender identification reflects an electronic mail account from which the subscriber is willing to accept data transmissions, commonly referred to as an address book. The sender identifications are stored in the authentication database 26.

In addition to the list of authorized sender identification, the subscriber inputs a ‘secret’. The ‘secret’ is an authorization code that can be used by the subscriber to authorize third parties not yet listed in the authentication database to transmit information to the subscriber. In this manner, the subscriber does not need to constantly update the authentication database, but rather, can simply provide the third party the secret. For the third party's transmission to be authorized, the sender must include the ‘secret’ within the transmission in a predefined place. In one preferred embodiment, the secret must be contained within the subject line or ‘re’ line of the transmission. The secret can be any combination of lettering, numbers, symbols and the like, such as, for example, the subscriber's birth date, parent's name, or completely arbitrary combination. In some preferred embodiments, a user forwarding a transmission containing the secret can be automatically added to the authentication database. In other preferred embodiments, the user's identification is not automatically included in the authentication database and the user must always use the secret in transmissions. This allows the member more control in the use of the secret, as it allows the secret to be changed and automatically block all users utilizing the secret without the need to amend the authentication database.

The subscriber is allowed to use the account directly, in conjunction with a separate electronic mail account, or a combination of both. If the subscriber utilizes the account directly, the subscriber can transmit and receive electronic mail in the account. If the subscriber utilizes the account in conjunction with a separate, but related account, for example, a Yahoo! account, the subscriber can receive electronic transmissions in the separate account and retrieve the messages via the filtering system account. In this manner, the member is not required to reestablish an electronic mail address, but can maintain preexisting addresses and simply access them from one location. During registration, or any time thereafter, the member provides a list of electronic mail accounts that the user desires to access from the filtering system. Thus, upon access to the filtering system, the member can choose, via a pull down list or other suitable means, the address location to access. When the member accesses the chosen mail account, the filtering system downloads the transmission in that box utilizing the preestablished filters.

If the user uses the account in conjunction with a separate account, the subscriber must also provide the electronic mail filtering system with the user name and password for the separate account. In this regard, when the subscriber attempts to access the account via the POP servers to retrieve the data transmissions submitted to the separate account, that is, the electronic mail, the filtering system can access and retrieve the data transmissions stored in the separate account. Once all the transmissions are retrieved, the POP server transmits a request for authentication to the filtering engine 30. Upon receipt of the request, the filtering engine 30 authenticates each transmission retrieved from the separate account. If the transmission is acceptable, the transmission is placed in the subscriber's inbox for review. If the transmission is not accepted, an unauthorized transmission message is forwarded to the sender and the message is discarded and not stored.

As shown from the discussion above, the accuracy and usefulness of the filters to block unwanted transmissions is dependent, in part, upon the accuracy of the authentication database 26. To facilitate the management of the account, preferred embodiments of the electronic mail system includes various management features that minimize the subscriber's requirement to update information. For example, as discussed, to receive a transmission from a sender, the sender's user name must be included within the authentication database. Updating the authentication database can be cumbersome. Thus, in preferred embodiments, in addition to manually amending the database, a subscriber can update the authentication database by transmitting a message to a third party not listed in the authentication database. As the subscriber attempts to transmit the message, the POP server reviews the recipient's user name, and compares the recipient's user name to those contained in the authentication database. If the user name is not included, the POP server transmits the user name to the authentication database for inclusion. In some preferred embodiments, an indicator, such as a check box, is included in the transmitted message if the subscriber does not want to update the authentication database. In this manner, the user can forward an electronic message to a recipient, but not agree to receive transmissions from the recipient. For example, a salesman, such as a car salesman, asks the subscriber to indicate by a particular time if they are interested in a vehicle. The subscriber can obtain the electronic mail address for the salesman and respond without exposing his electronic mail account to undesired solicitation or repetitive inquiries regarding purchasing the vehicle.

In addition to automatically updating the authentication database, the subscriber can suspend a user name without deleting the name. In this manner, as the name has not been deleted, the subscriber can later remove-the suspension of the user name without having to transmit an electronic transmission or provide the user with the secret. In some preferred embodiments, a box can be checked to signify that the user is suspended. Further still, as discussed above, the subscriber can change the ‘secret’ at any time. In embodiments wherein the identification of the user utilizing the secret is not automatically added to the authentication database, if the secret has become known, the subscriber can automatically, and without effort, block undesired transmissions by changing the secret and thereby avoid having to amend the authentication database by deleting or suspending the user name(s) that obtained the secret erroneously or otherwise.

In addition to the features discussed above, the electronic mail system allows the subscriber to temporarily establish an electronic mail address. The electronic mail address can be established for a predefined period of time and is not connected to the authentication database Thus, any recipients receiving transmissions from the subscriber through the temporary mail address will not be updated into the authentication database. In this manner, a subscriber can conduct transactions on-line without fear of exposing the electronic mail account to unending solicitations and unsolicited transmissions. Thus, for example, the temporary electronic mail account allows subscribers to order items on-line, or register on-line and receive a confirmation for their transactions. Once the predefined time period has expired, any transmission emanating from the temporary e-mail account will be blocked and no longer accepted.

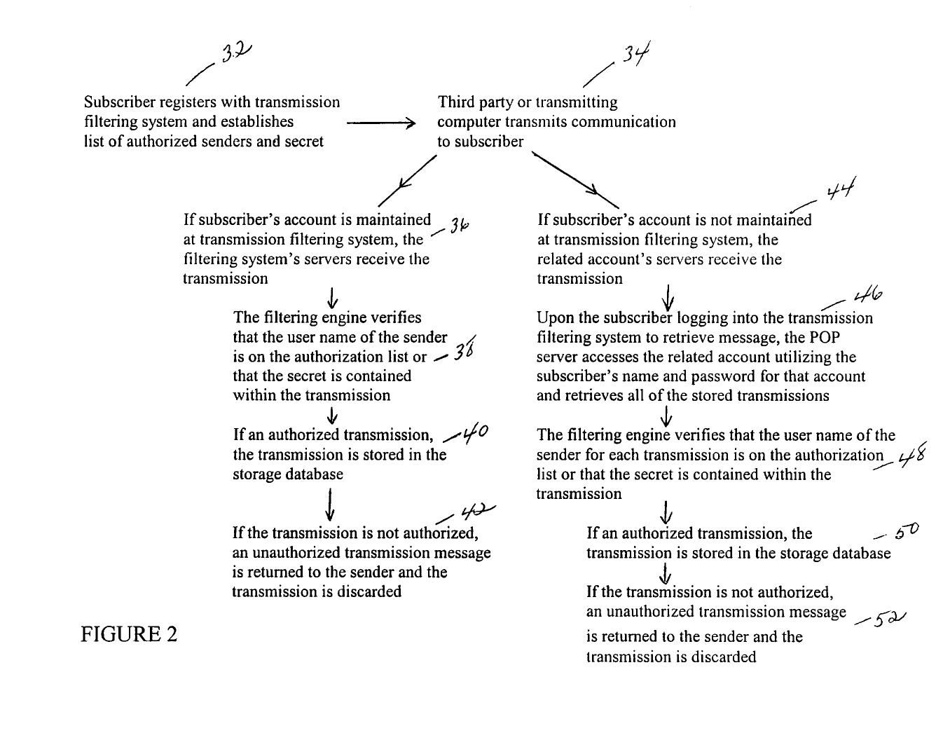

With reference to FIG. 2, in operation, a subscriber registers with the transmission filtering system and establishes an authorized list of user names in the authentication database and an authorization code, or secret 32. A third party or transmitting computer forwards a transmission to the subscriber or client computer 34. If the subscriber's receiving address is an account maintained by the transmission filtering system, the transmission is received at the provider computer's SMTP servers 36. Upon receipt of the transmission, SMTP servers transmit a request for authentication of the transmission to the filtering engine. In response to the request for authentication, the filtering engine determines whether the transmission is authorized 38 by comparing the user name to the list of authorized users in the authentication database. If the user name is not found in the list of authorized user names, the filtering engine reviews the transmission to determine whether the authorization code is contained within the transmission, such as in the subject line. If the transmission is authorized, the transmission is stored in the storage database 40. If the transmission is not authorized, an unauthorized transmission message is transmitted to the sender and the transmission is discarded 42.

If the subscriber's receiving address does not reflect an account maintained by the electronic mail filtering system, for example, a Yahoo! account, the transmission is received by the SMTP servers of the related account and is stored on the storage locations of the related account 44. When the subscriber desires to retrieve the stored transmissions on the related account, the subscriber can log into the electronic mail filtering system. Upon logging into the account, the POP servers retrieve the transmissions stored in the related account, wherein the POP servers utilize the subscriber's name and password for that account 46. Once the POP servers retrieve the transmissions, prior to storing the transmissions in the storage database or transmitting them to the subscriber's inbox, the POP servers transmit a request for authentication to the filtering engine. Upon receipt of the request, the filtering engine compares the user names of each message to the authentication database 48. If the user name is not contained within the authentication database, the filtering engine reviews the transmission for the secret 48. If authorization can be confirmed, as discussed above, the transmission is stored in the storage database and transmitted to the subscriber's inbox 50. If authorization cannot be established, an unauthorized transmission message is forwarded to the sender and the message is discarded 52

Although the foregoing described the invention with preferred embodiments, this is not intended to limit the invention. Indeed, it is to be understood that embodiments of the invention allow for partial blocking of transmissions as well as completely blocking the receipt of all unsolicited transmissions. In some preferred embodiments, a member can establish a ‘junk’ mail box, wherein, if desired, the member can review all of the blocked transmissions. In this manner, the system is only partially blocking the transmission in that the member can voluntarily review the blocked mail in a secondary location. In addition to the above described embodiments, the foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

What is claimed is:

1. A method for filtering transmitted data on a computer network having a provider computer, a client computer and a transmitting computer, wherein the provider computer, the client computer and the transmitting computer are in communication therebetween, and wherein the transmitting computer includes a source identification, the method comprising:
defining a filtering mechanism by the client computer, wherein the presence of the filtering mechanism in transmitted data authorizes the receipt of the data by the client computer,
defining a list of authorized source identifications from which the client computer accepts data transmissions;
receiving, by the provider computer from the transmitting computer, a data transmission;
determining whether the data transmission is authorized; and
if the data transmission is authorized providing the data transmission from the provider computer to the client computer;
if the data transmission is unauthorized, preventing the transmission of the data transmission from the provider computer to the client computer.

2. A method as claimed in claim 1, wherein determining whether the data transmission is authorized comprises determining whether the filtering mechanism is present in the data transmission.

3. A method as claimed in claim 2, further comprising adding the source identification of the transmitting computer to the list of authorized sources if the filtering mechanism is present in the data transmission.

4. A method as claimed in claim 1, wherein determining whether the data transmission is authorized comprises comparing the source identification of the transmitting computer to the list of authorized source identifications.

5. A method as claimed in claim 1 further comprising updating the list of authorized source identifications by transmitting a data transmission from the client computer to the transmitting computer, wherein upon the transmission of data from the client computer the source identification of the transmitting computer is added to the list of authorized source identifications.

6. A method as claimed in claim 1 further comprising transmitting, from the provider computer to the transmitting computer, a notification that the transmitted data was not received by the client computer if the data transmission by the transmitting computer is determined to be unauthorized.

7. A method as claimed in claim 1 further comprising suspending at least one authorized source identification on the list, wherein the suspension of the source identification prevents the receipt of a data transmission from that source identification to the client computer, and wherein suspension of the source identification does not remove the source identification from the list of authorized source identifications.

8. A system for filtering transmitted data on a computer network having a provider computer, a client computer and a transmitting computer, wherein the provider computer, the client computer and the transmitting computer are in communication therebetween, and wherein the transmitting computer includes a source identification, the system comprising:
a filtering code, wherein the filtering code is defined by the client computer, and wherein the presence of the filtering code in transmitted data authorizes the receipt of the data by the client computer;
a list of authorized source identifications from which the client computer accepts data transmissions;
means for receiving, by the provider computer from the transmitting computer, a data transmission; and
a filtering engine, wherein the filtering engine is configured to determine whether the data transmission is authorized and, based upon the determination, transmit the data to the client computer or prevent the transmission of the data transmission to the client computer.

9. A system for filtering transmitted data as claimed in claim 7, wherein to determine whether the transmission is authorized the filtering engine determines whether the filtering code is present or whether the transmission is from an authorized source identification.

10. A system for filtering transmitted data as claimed in claim 8, further comprising a means for suspending the receipt of transmissions from a specific source identification on the list of authorized source identifications.

11. A system for filtering transmitted data as claimed in claim 8, further comprising a means for identifying a plurality of electronic accounts, and means for accessing the plurality of electronic accounts, wherein the identified electronic accounts store received transmissions for the client computer.

12. A system for filtering transmitted data as claimed in claim 1 1, wherein the electronic accounts are electronic mail accounts residing on third party provider computers
